(19) United States
(12) Patent Application Publication
(10) Pub. No.: US 2005/0096417 A1
(43) Pub. Date: May 5, 2005

(54) Curable resinous compositions and scratch resistant countertops derived therefrom

(76) Inventor: James Michael Quackenbush, Round Rock, TX (US)

Correspondence Address: John Wilson Jones;Attn: IP Docketing Clerk, Locke, Liddell & Sapp LLP, 600 Travis, Suite 3400, Houston, TX, 77002, US

(21) Appl. No.: 10/700,233

(22) Filed: Nov. 3, 2003

(51) Int. Cl. C08K 5/09; C08K 3/34

(52) U.S. Cl. 524/284; 524/442

(57) ABSTRACT

A resinous curable composition comprises: (A) an epoxy resin; (B) at least carboxylic acid anhydride; (C) at least one inorganic filler, wherein at least 80% of the particles of the filler have a particle diameter size between about 10 to about 40 microns; and (D) at least one inorganic filler, wherein at least 80% of the particles of the filler have a particle diameter size greater than about 90 microns and is preferably either sand and/or granite chips. The curable composition may be hardened in the presence of a heat activated catalyst to render a scratch resistant hard surface, suitable for use as a countertop or laboratory bench top. The composition may contain as high as 89% inorganic filler.

### FIELD OF THE INVENTION

The invention relates to a curable resinous composition containing an epoxy resin and hardened scratch resistant countertops derived from such curable compositions.

### BACKGROUND OF THE INVENTION

The hardness and durability of stone and other naturally occurring materials for working surfaces has been admired through the centuries. However, the expense and availability of such surfaces limits many persons from enjoying such surfaces.

Some prior efforts have made surfaces more available by combining hardening resins with naturally occurring fill material. In some cases, the resins such as polyester acrylics have been used with naturally occurring fill materials. One such product is known as Avonite®. Another commercially available product by Dupont is Corian® which can include a variety of fill materials.

However, the surfaces from these materials are generally designed for residential and light commercial use. They are not as durable physically or chemically as some applications require for long-term use. Further, some more expensive materials at about two to three times the price of the above materials can offer durability but again are priced at a range that limits many persons from enjoying such surfaces.

Some additional examples include an epoxy thermosetting material as part of a resin matrix and fill materials of metal or stone particles. For example, U.S. Pat. No. 6,365,662 to Sakai discloses an artificial stone comprising an inorganic particle component of 82-93% by weight of a mixture of small and large particles of specific size ranges and a resin component of 7-18%. The resin component can include thermosetting resins such as acrylics, methacrylics, unsaturated polyesters, and epoxies. Another example, WO 99/00235, discloses a resin matrix bound to a substrate where the resin matrix contains a curable liquid resin, metal or stone particles, and a catalyst. The curable resin can be acrylates, methacrylates, styrenes, methylstyrenes, allys, diallylphthalates, unsaturated polyesters, vinyl esters, urethanes and epoxies. The catalyst can include aliphatic amines, aromatic amines, catalytic curing agents and acid anhydrides. Other known efforts include using an epoxy resin in conjunction with an anhydride and silica as the fill material to form a mixture and then catalyzing the mixture with an amine.

Nevertheless, the industry is still lacking in a particular process and corresponding product that combines the benefits of an epoxy resin with mineral fill materials in a particular manner to produce a commercially viable and relatively inexpensive manufactured structural synthetic surface. The synthetic surface needs the combination of scratch resistance and hardness while being durable and impact resistant at a moderate costs. Therefore, there remains a need in the industry for such a material.

### SUMMARY OF THE INVENTION

The invention relates to a resinous curable composition and hardened surfaces derived therefrom. The resinous curable composition contains an epoxy resin and at least one carboxylic acid anhydride, along with multiple sized inorganic filler materials which serve to increase the loading capacity of the composition. The composition is hardened in the presence of a heat-activated catalyst. The resulting product is harder and more scratch resistant than other known commercially available materials and, further, is cheaper to produce. The hardened surface may be a countertop such as a kitchen countertop, laboratory bench countertop and other type of working surface.

The curable resinous composition of the invention comprises:
(A) an epoxy resin;
(B) at least one carboxylic acid anhydride;
(C) at least one inorganic filler, wherein at least 80% of the particles of the filler have a particle diameter size between about 10 to about 40 microns; and
(D) at least one inorganic filler, wherein at least 80% of the particles of the filler have a particle diameter size greater than about 90 microns; preferably either sand and/or granite chips.

The resinous composition of the invention employs dramatically less epoxy resin and more fillers than the formulations of the prior art. As such, the resinous compositions of the invention can be more economically produced than the compositions of the prior art.

### DETAILED DESCRIPTION OF THE PREFERRED EMBODIMENTS

The curable resinous composition of the invention contains an epoxy resin. Typically, the amount of epoxy resin in the resinous curable composition is less than 15 weight percent, typically less than 13 weight percent. In some cases, the amount of epoxy resin in the resinous curable composition may be as low as 6 weight percent. For instance, where granite chips and/or sand are used as the inorganic filler (D) of the curable resinous composition, the amount of requisite epoxy resin is generally half of that required in the more traditional epoxy resin formulations.

The epoxide resin may be a cycloaliphatic epoxide resin, i.e. a resin that has a least one epoxide group in which the oxygen atom is attached to carbon atoms in a cycloaliphatic ring, a N-glycidylamine, a polyglycidyl ester of a polycarboxylic acid or a polyglycidyl ether of a polyhydric alcohol or phenol. Generally, epoxy resins contain aliphatic, cycloaliphatic or aromatic backbones. One type of epoxy resin preferred for use in accordance with the invention is a polyfunctional epoxy composition containing at least three epoxide groups.

Preferred resin compositions include those comprising at least one glycidyl ether of a polyhydric phenol such as 2,2-bis(4-hydroxyphenyl)propane (bisphenol A), bis(4-hydroxyphenyl)methane (bisphenol F), a phenol formaldehyde novolak or a cresol-formaldehyde novolak. Examples of epoxy resins preferred for this invention include 2,2-bis[4-(2,3-epoxypropoxy)phenyl]propane (diglycidyl ether of bisphenol A) and materials under the trade designation “Epon 828”, “Epon 1004” and “Epon 1001F”, commercially available from Resolution Performance Polymers, “DER-331”, “DER-332” and “DER-334”, commercially available from Dow Chemical Co. Other suitable epoxy resins include glycidyl ethers of phenol formaldehyde novolac (e.g., “DEN-43” and “DEN-428”, commercially available from Dow Chemical Co.). Such resins preferably have a weight average molecular weight less than about 20,000, most preferably less than 14,000.

Epoxy resins may further include monomeric epoxy resins as well as polymeric epoxy resins. These resins can vary greatly in the nature of their backbones and substituent groups. For example, the backbone may be of any type normally associated with epoxy resins and substituent groups thereon can be any group free of an active hydrogen atom that is reactive with an oxirane ring at room-temperature. Representative examples of substituent groups for epoxy resins include halogens, ester groups, ether groups, sulfonate groups, siloxane groups, nitro groups, and phosphate groups.

Generally, the polyfunctional epoxy compounds of the invention may be derived from any number of sources, including the reaction product of chlorohydrin compounds such as epichlorohydrin, glycerol dichlorohydrin, and beta-methylepichlorohydrin with polycarboxylic acid compounds including aromatic and aliphatic polycarboxylic acids such as tri and tetra carboxylic acids; with polyhydroxyl compounds such as alcoholic and phenolic polyhydroxyl compounds; with amine compounds comprising three or more amino hydrogen atoms including aliphatic, cycloaliphatic, and aromatic amines; with polythiol compounds; and with polyene type unsaturated cycloaliphatic compounds.

Further, desirable epoxy resins include those derived from saturated and unsaturated polyfunctional alcohols such as tetritols, pentitols, and hexitols such as sorbitol, and maltitol. One group of preferred polyfunctional epoxies are aliphatic epoxy resins of hexitol polyglycidyl ethers such as sorbitols and maltitols. Polyfunctional epoxy resins are available from suppliers such as Dow Chemical, Ciba Geigy, Rhone-Poulenc, Resolution Performance Polymers as well as from Dixie Chemical Company of Houston, Tex. which offers the sorbitol polyglycidyl ether as Dixie DCE 358.

The carboxylic acid anhydride for use in the invention typically comprises from about 4 to about 15, preferably from about 6 to about 10, weight percent of the curable composition.

Preferred as the carboxylic acid anhydride are aromatic acid anhydrides such as phthalic acid anhydride, isophthalic acid anhydride, terephthalic acid anhydride, pyromellitic acid and benzophenone-3,3′,4,4′-tetracarboxylic acid as well as alicyclic aromatic acid anhydrides such as tetrahydrophthalic acid anhydride, methyltetrahydrophthalic acid anhydride, hexahydrophthalic acid anhydride, methylhexahydrophthalic acid anhydride, methylendomethylenetetrahydrophthalic acid anhydride, hexahydroterephthalic acid anhydride, 4-methyltetrahydrophthalic acid anhydride, tetrahydroisophthalic acid anhydride, endomethylenetetrahydrophthalic acid anhydride as well as alkenylsuccinic anhydrides, maleic anhydride, succinic anhydride, glutaric anhydride and fumaric anhydride. More preferred blends include methyltetrahydrophthalic anhydride, hexahydrophthalic anhydride and methylhexahydrophtahlic anhydride and especially preferred is a 45:55 to 55:45 weight ratio blend of hexahydrophthalic acid anhydride:methylhexahydrophthalic acid anhydride.

In a most preferred mode, two or more carboxylic acid anhydrides are used; most preferably at least one carboxylic acid anhydride is an aromatic acid anhydride and the second is an alicyclic aromatic acid anhydride. In an even more preferred embodiment, the aromatic acid anhydride is a flake material. When so employed, the molar ratio of aromatic acid anhydride:alicyclic aromatic acid anhydride is generally from about 1.2:0.8 to 0.8:1.2.

The composition of the invention further contains as high as 75, and may be as high as 89, weight percent of inorganic filler. Such inorganic filler loadings are higher than the permissible inorganic filler loadings of the compositions of the prior art formulations. As a result, the amount of epoxy resin employed in the composition is reduced.

One of the inorganic fillers, defined as “inorganic filler (D)”, are particulates having high particle diameter sizes. For instance, 80% of the particulates of such inorganic fillers are typically characterized by a particle size greater than about 90 microns. Such particulates are typically sand or chips of natural stone, such as granite, tuff, marble, sandstone and the like or a combination thereof. When both granite and sand are employed, their approximate weight ratio is between from about 2:1 to about 1:1. The sand, in addition to containing silica, may contain trace amounts of iron oxide, aluminum oxide, titanium dioxide, calcium oxide, and magnesium oxide as well as other oxides. The use of natural stone chips is most preferred because the amount of epoxy resin required to be employed, when such chips are used as the inorganic filler, is almost half of that required in the epoxy resin formulations of the prior art. In a most preferred mode, at least 80% of the chips of natural stone have a particle size diameter greater than 1/8 inch.

In addition to the above-described inorganic fillers, the curable composition of the invention further contains a second inorganic filler, defined as “inorganic filler (C)”. Such inorganic fillers have much smaller average particle size diameter than inorganic fillers (D); typically, at least about 80% of the particles of inorganic filler (C) have a particle diameter size of from between about 10 to about 40 microns. Exemplary of such inorganic fillers are naturally occurring inorganic materials such as silica stone, silica sand, diatomaceous earth, kaolin, halloysite, montmorillonite, bentonite, zeolite, phosphorite, diaspore, gibbsite, bauxite, Japanese acid clay, porcelain stone, pyrophyllite rock, feldspars, limestone, wollastonite, gypsum, dolomite, magnesite and talc. In a preferred embodiment, the (second) inorganic filler is sand.

In a preferred embodiment, inorganic filler (C) is sand and inorganic filler (D) is sand and/or granite chips. The weight ratio of the sand of inorganic filler C:inorganic filler D is typically 7:1 to about 1:1.5. Particularly desirous results have been obtained where the inorganic filler D is a combination of sand and granite chips. In such instances, the weight ratio of the sand of inorganic filler C to the sand of inorganic filler D is approximately 1:1 and the weight ratio of total sand (of inorganic filler (C) and inorganic filler (D)) to the granite chips is about 1:1.

The resinous composition of the further invention may be cured by heating, preferably in the presence of a heat activated catalyst. Typical heat activated catalysts include cycloaliphatic and aromatic polyamines, polyhydric phenols or an imidazole.

The following non-limiting examples, and comparative demonstrations, bring out the more salient features of the invention. All parts are given in terms of weight units except as may otherwise be indicated.

As used below:
Granite refers to #0 granite chips, about 1/8 inch diameter;
200 Sand refers to Unimin No. 200 sieve silica sand (80% of the particulates having a particle diameter size range of 10 to 40 microns);
325 Sand refers to Unimin No. 325 sieve silica sand (80% of the particulates having a particle diameter size range of about 10 to 25 microns);
7010 Sand refers to Unimin No. 7010 sieve silica sand (80% of the particulates having a particle diameter size range of about 90 to 150 microns);
Epon 828 is a commercially available epoxy resin from Resolution Performance Polymers.

Liquid Anhydride Mix refers to ECA 100H, available from Dixie Chemical Company of Houston, Tex., is a mixture of from about 0-5% by weight methyltetrahydrophthalic anhydride, 45-50% by weight hexahydrophthalic anhydride and 45-50% by weight methylhexahydrophthalic anhydride;
flake phthalic anhydride refers to melted flake phthalic anhydride, available from Koppers; and
LINDAX 1 is 1-(2 hydroxypropyl) imidazole heat activated catalyst, available from The Lindau Company.

### EXAMPLES

200 Sand and, where desired, 325 Sand, 7010 Sand and Granite were blended together. The blend was then added to the epoxy resin, flake phthalic anhydride and Liquid Anhydride Mix while maintaining a temperature of about 240° F. The mixture was then combined with about 0.03% by weight of LINDAX 1. The catalyzed mixture was then conveyed by pouring or troweling into a hot mold and baked at 270° F. for curing. It was then removed from the mold and placed in a different oven at 310° F. as a post cure operation. The physical properties of the compositions are set forth in Table II and the compositions in Table I. The compositions of the invention are further compared against a known prior art formulation, Comparative Example 1, set forth in Table I.

TABLE I

| | Comparative | Example I, | Example II, |
|---|---|---|---|
| | Example 1, | % by | % by |
| Ingredient | % by weight | weight | weight |
| Epoxy Resin | 14.8 | 12.6 | 7.14 |
| Flake Phthalic | 6.8 | 5.8 | 3.29 |
| Anhydride | | | |
| Liquid | 5.3 | 4.6 | 2.57 |
| Anhydride | | | |
| Mix | | | |
| 200 Sand | 58.4 | 65.4 | 21.75 |
| 325 Sand | 14.6 | | |
| 7010 Sand | | 11.6 | 21.75 |
| Granite Chips | | | 43.5 |

TABLE II

| | | Comparative | | |
|---|---|---|---|---|
| test | ASTM method | Example 1 | Ex No. 1 | Ex. No. 2 |
| % water absorption | D 570 | 0.027 | 0.010 | |
| fire resistance | D 635 | self ex. | DNI | |
| specific gravity | D 792 | 2.00 | 2.06 | 2.32 |
| Rockwell M hardness | D 785 | 105 | 108 | |
| heat dist temp | D 648 | 380 | 380 | |
| flex strength | D 790 | 11,933 | 11,300 | 2,840 |
| flex. modulus | D 790 | 2,120,000 | 2,210,000 | 1,508,000 |
| compressive strength | D 695 | 31,946 | 30,509 | |
| tensile strength | D 638 | 6,732 | 5,395 | |
| coeff. expansion/contraction | D 696 | 2.7 × 10-5 | 2.20 × 10-5 | 1.16 × 10-5 |
| Scratch Resistance | | Standard | Standard | Much Above Standard |

From the foregoing, it will be observed that numerous variations and modifications may be effected without departing from the true spirit and scope of the novel concepts of the invention.

1. A curable resinous composition comprising:
(A) an epoxy resin;
(B) at least one carboxylic acid anhydride;
(C) at least one inorganic filler wherein at least 80% of the particles of the filler have a particle diameter size of from between about 10 to about 40 microns; and
(D) at least one inorganic filler wherein at least 80% of the particles of the filler have a particle diameter size greater than about 90 microns.

2. The curable resinous composition of claim 1, wherein the at least one inorganic filler of (C) is sand.

3. The curable resinous composition of claim 1, wherein the at least one inorganic filler of (D) is granite chips.

4. The curable resinous composition of claim 1, wherein the at least one carboxylic acid anhydride is selected from methyltetrahydrophthalic anhydride, hexahydrophthalic anhydride and methylhexahydrophthalic anhydride.

5. The curable resinous composition of claim 4, wherein the at least one carboxylic acid anhydride is a mixture of two or more anhydrides selected from methyltetrahydrophthalic anhydride, hexahydrophthalic anhydride and methylhexahydrophthalic anhydride.

6. The curable resinous composition of claim 5, wherein the at least one carboxylic acid anhydride is a mixture of from about 45-55% by weight hexahydrophthalic anhydride and 55-45% by weight methylhexahydrophthalic anhydride.

7. The curable resinous composition of claim 1, wherein the at least one carboxylic acid anhydride is an anhydride of phthalic acid, isophthalic acid, pyromellitic acid and benzophenone-3,3′,4,4′-tetracarboxylic acid.

8. The curable resinous composition of claim 7, wherein the at least one carboxylic acid anhydride is phthalic anhydride.

9. The curable resinous composition of claim 8, wherein the phthalic anhydride is flake phthalic anhydride.

10. The curable resinous composition of claim 1, wherein the at least one inorganic filler of (C) is a naturally occurring inorganic material.

11. The curable resinous composition of claim 10, wherein the naturally occurring inorganic material is selected from silica stone, silica sand, diatomaceous earth, kaolin, halloysite, montmorillonite, bentonite, zeolite, phosphorite, diaspore, gibbsite, bauxite, Japanese acid clay, porcelain stone, pyrophyllite rock, feldspars, limestone, wollastonite, gypsum, dolomite, magnesite and talc.

12. The curable resinous composition of claim 11, wherein the naturally occurring inorganic material is sand.

13. The curable resinous composition of claim 1, wherein the at least one inorganic filler of (D) is sand.

14. The curable resinous composition of claim 1, wherein the at least one inorganic filler of (D) is granite chips.

15. The curable resinous composition of claim 13, wherein the at least one inorganic filler of (D) further comprises granite chips.

16. The curable resinous composition of claim 15, wherein the weight ratio of granite chips:sand in inorganic filler (D) is between from about 2:1 to about 1:1.

17. The curable resinous composition of claim 15, wherein the at least one inorganic filler of (C) is sand and further wherein the weight ratio of inorganic filler sand (C):inorganic filler sand (D):granite chips is approximately 1:1:2.

18. A curable resinous composition comprising:
(A) an epoxy resin;
(B) at least one carboxylic acid anhydride;
(C) at least one naturally occurring inorganic material; and
(D) granite chips.

19. The curable resinous composition of claim 18, wherein the at least one carboxylic acid anhydride is selected from an anhydride of phthalic acid, isophthalic acid, pyromellitic acid, benzophenone-3,3′,4,4′-tetracarboxylic acid, methyltetrahydrophthalic acid, hexahydrophthalic acid and methylhexahydrophthalic acid.

20. The curable resinous composition of claim 19, wherein the at least one carboxylic acid anhydride is the combination of (i.) an aromatic polycarboxylic acid selected from an anhydride of phthalic acid, isophthalic acid, pyromellitic acid and benzophenone-3,3′,4,4′-tetracarboxylic acid; and (ii.) at least one alicyclic anhydride selected from methyltetrahydrophthalic anhydride, hexahydrophthalic anhydride and methylhexahydrophthalic anhydride; anhydride.

21. The curable resinous composition of claim 20, wherein the at least one alicyclic anhydride is a mixture of from about 45-55% by weight hexahydrophthalic anhydride and 55-45% by weight methylhexahydrophthalic anhydride.

22. The curable resinous composition of claim 18, wherein the at least one carboxylic acid anhydride is flake phthalic anhydride.

23. The curable resinous composition of claim 18, wherein the at least one naturally occurring inorganic material is selected from silica stone, silica sand, diatomaceous earth, kaolin, halloysite, montmorillonite, bentonite, zeolite, phosphorite, diaspore, gibbsite, bauxite, Japanese acid clay, porcelain stone, pyrophyllite rock, feldspars, limestone, wollastonite, gypsum, dolomite, magnesite and talc.

24. The curable resinous composition of claim 23, wherein the naturally occurring inorganic material is sand.

25. The curable resinous composition of claim 24, wherein at least 80% of the sand particles have a particle diameter size between from about 10 to about 40 microns.

26. The curable resinous composition of claim 25, further comprising at least one inorganic filler wherein at least 80% of the particles of the filler have a particle diameter size between from about 90 to about 150 microns.

27. A curable resinous composition comprising:
(A) an epoxy resin;
(B) phthalic acid anhydride;
(C) a mixture of at least two anhydrides selected from methyltetrahydrophthalic anhydride, hexahydrophthalic anhydride and methylhexahydrophthalic anhydride;
(D) sand; and
(E) granite chips.

28. The curable resinous composition of claim 21, wherein at least 80% of the sand particles of (D) have a mean particle size between from about 10 to about 40 microns.

29. A curable resinous composition which comprises:
(A) an epoxy resin;
(B) at least one anhydride of an aromatic polycarboxylic acid selected from an anhydride of phthalic acid, isophthalic acid, pyromellitic acid and benzophenone-3,3′,4,4′-tetracarboxylic acid;
(C) at least one alicyclic anhydride selected from methyltetrahydrophthalic anhydride, hexahydrophthalic anhydride and methylhexahydrophthalic anhydride;
(D) sand, wherein at least 80% of the sand particles have a particle diameter size of from between about 10 to about 40 microns; and
(E) at least one inorganic filler, wherein at least 80% of the particles of the inorganic filler have a particle diameter size greater than about 90 microns.

30. The curable resinous composition of claim 29, wherein the at least one inorganic filler is sand or granite chips.

31. The curable resinous composition of claim 29, wherein the at least one inorganic filler is sand and granite chips.

32. A scratch resistant countertop comprising the hardened composition of claim 1.

33. The scratch resistant countertop of claim 1, wherein the resinous composition is hardened in the presence of a heat activated catalyst.

34. A scratch resistant countertop comprising the hardened composition of claim 18.

35. The scratch resistant countertop of claim 34, wherein the resinous composition is hardened in the presence of a heat activated catalyst.
